(19) United States
(12) Patent Application Publication
(10) Pub. No.: US 2026/0149584 A1
(43) Pub. Date: May 28, 2026

(54) SYSTEMS AND METHODS FOR ENHANCED DEVICE-BOUND PASSKEY ENROLLMENT

(71) Applicant: Wells Fargo Bank, N.A., San Francisco, CA (US)

(72) Inventors: Brad Stinson, Charlotte, NC (US); Kimberly R. Nelson, Charlotte, NC (US); Matthew N. Wheeler, Charlotte, NC (US)

(21) Appl. No.: 18/957,172

(22) Filed: Nov. 22, 2024

(51) Int. Cl. H04L 9/30

(52) U.S. Cl. CPC H04L 9/30; H04L 9/3215; H04L 63/0853; H04L 63/18

(57) ABSTRACT

Systems, apparatuses, methods, and computer program products are disclosed for device-bound passkey enrollment. An example method includes receiving a first channel authentication response from a user device over a first communication channel and determining a first channel authentication result. The example method further includes in response to determining a successful first channel authentication result, transmitting, an enhanced authentication request and receiving an enhanced authentication response from the user device over a second communication channel. The example method further includes determining an enhanced authentication result and in response to determining a successful enhanced authentication result, transmitting a permissioned passkey generate request to the user device. The example method further includes receiving a public key from the user device and storing the public key in a user profile associated with the user.

### BACKGROUND

Users may frequently request access to resources (e.g., data) that are stored securely. Entities that store secured resources often authenticate a user before granting the user access to requested data. However, data that is transmitted to authenticate a user is susceptible to data interception and/or tampering.

### BRIEF SUMMARY

Passkeys may be utilized to provide a secure and user-friendly user authentication technique. For example, since passkeys leverage private-public key cryptography, they eliminate the need for a user to provide an entity with a shared secret authentication factor (e.g., a password), which are vulnerable to malicious attacks from bad actors (e.g., phishing attacks, brute force attacks, credential leaks, or the like). As such, passkeys are now ubiquitous in society, and therefore entities in all industries may implement passkey authentication techniques to authenticate their users. However, a reliance on passkeys for authentication may expose an entity that is storing sensitive data and the users in which the sensitive data pertains to unique risks, given that a bad actor could potentially register unauthorized devices with a passkey that may ultimately be utilized to gain access to sensitive data (e.g., personal identifiable information (PII), or the like). In this regard, thoughtful device-bound passkey enrollment techniques are required to ensure the security of sensitive data.

Traditionally, to enable passkey authentication, an entity may implement a device-bound passkey enrollment technique that is designed to enable the safe and secure provision of a device-bound passkey to a computing device associated with a user. For example, after initially authenticating a user via a traditional user authentication technique (e.g., verifying a user's username and password), an entity may transmit a request that instructs a computing device associated with the authenticated user to generate a cryptographic key pair. The computing device may then generate the cryptographic key pair (e.g., using a secure enclave) and may securely store the private key (e.g., in a secure enclave), while the public key may be transmitted to the entity (e.g., a server associated with the entity) that provisioned the device-bound passkey, which may then be used to ultimately verify signatures signed by the private key.

While a device-bound passkey enrollment technique that provisions a device-bound passkey after an initial user authentication operation may allow a computing device associated with an authenticated user to generate a device-bound passkey, the use of a singular authentication operation to verify a user's identity has several drawbacks. In particular, relying solely upon the verification of a singular authentication factor is vulnerable to a bad actor that may discover or otherwise obtain the singular authentication factor. In this regard, upon discovering and/or obtaining a singular authentication factor associated with a user, the bad actor may subsequently initiate a passkey enrollment procedure to enroll a computing device not associated with the user, which may grant the bad actor continuous access to secure data that is (i) associated with the entity provisioning the passkey and/or (ii) associated with the user in which the discovered and/or obtained authentication factor corresponds. For example, a weak or reused password may be easily exposed in a data breach. As a result, a bad actor who obtained a user's password may seamlessly bypass the required authentication by using the obtained password. To this end, a bad actor may initiate a passkey generation on their (e.g., the bad actor's) computing device, and thus may utilize the generated passkey to routinely withdraw money from a bad actor's account (e.g., a checking account).

Moreover, utilizing a singular authentication factor for user authentication does not account for the various security concerns associated with device-bound passkey enrollment techniques. For example, various factors, such as the location of the computing device, metadata pertaining to the particular request (e.g., the date/time of the request), the particular user account associated with the request, and/or the like, may impact the security measures (e.g., authentication operations) that are necessary to be performed to ensure the security of enrolling a particular device with a device-bound passkey. Since a traditional device-bound passkey enrollment technique merely implements a singular authentication factor verification operation before provisioning a passkey to a computing device, this technique is incapable of considering context-specific nuances that dynamically impact the security associated with passkey generation requests.

The inherent blind spots and limitations associated with securely and efficiently provisioning a device-bound passkey presents a technical problem. As such, a need exists for a solution that provides a dynamic multistage authentication process that adapts based on an inferred security (e.g., a security score) associated with a user request before enabling a device to generate a passkey. Example embodiments provide a technical solution to this technical problem because example embodiments do not require manual intervention. Further, by leveraging a security score that indicates an inferred security associated with a request to enroll a particular computing device with a device-bound passkey, example embodiments provide a technical solution that reduces the need for continuously performing computationally demanding authentication operations for each request for device-bound passkey enrollment. For example, example embodiments reduce the need for routinely performed computationally demanding authentication operations by selectively triggering the performance of computationally demanding authentication operations for particular user requests associated with triggering conditions (e.g., a particular location of a user device, a date/time the user request was received and/or generated, or the like). Moreover, by reducing the number of computationally demanding authentication operations, example embodiments avoid overburdening a passkey enrollment system with complex processes for low-risk passkey enrollment requests, and thus reduces latency and frees resources to process passkey enrollment requests that are associated with triggering conditions.

Example embodiments described herein mitigate the above concerns by creating and using a centralized system that leverages a security score to dynamically adjust the multistage authentication operations that are necessary to ensure the security of enrolling a particular device with a device-bound passkey. To do so, example embodiments may receive a first channel authentication response from a user device over a first communication channel (e.g., a traditional telephone network, voice over internet protocol (VoIP) system, or the like). The first channel authentication response may be an electronic response that is received via the first communication channel. The first channel authentication response may include call data, such as authentication data associated with the user and/or user account, an indication of a requested action or service, or the like. Example embodiments may then determine, based on the first channel authentication response, a first channel authentication result. The first channel authentication result may indicate whether the authentication data included in the first channel authentication response corresponds to verified first channel authentication data (e.g., a successful first channel authentication response).

In response to determining a successful first channel authentication result, example embodiments may transmit an enhanced authentication request to the user device. The enhance authentication request may be an electronic request that includes an enhanced authentication link that points to an endpoint where a user may provide requested authentication data. For example, the enhanced authentication link may include a pointer that directs the user to a particular location, such as a webpage or mobile application logon page. Example embodiments may then receive an enhanced authentication response from the user device over a second communication channel (e.g., in-application messaging, email, or the like) that is different than the first communication channel. The enhanced authentication response may refer to an electronic response that includes authentication data that was requested in the enhanced authentication request. In some embodiments, the enhanced authentication data may include authentication factors that are less likely by to be forged, guessed, or otherwise obtained by a bad actor than a password, PIN, or the like, due to the inherent complexity involved in authentication factor verification. For example, the enhanced authentication response may include authentication data (e.g., biometric data), an indication of an electronic government-issued identifier (e.g., a mobile driver's license (mDL), an image of the user, an image of a government-issued identifier, or the like. Example embodiments may then determine an enhanced authentication result based on the received enhanced authentication response. The enhanced authentication result may indicate whether the received authentication data (e.g., authentication data received via the enhanced authentication response and requested in the enhanced authentication request) corresponds to verified enhanced authentication data.

In response to determining that the enhanced authentication result corresponds to a successful enhanced authentication result (e.g., an enhanced authentication result that indicates that the received enhanced authentication data is successfully verified), example embodiments may transmit a permissioned passkey generation request to the user device that transmitted the enhanced authentication response. The permissioned passkey generation request may refer to an electronic request that instructs a particular user device to generate a passkey. Example embodiments may then receive a public key from the user device. Example embodiments may then store the public key in a user profile associated with the user. The user profile may refer to a data construct that may store data (e.g., user profile data, or the like) that was collected by the centralized system and may be utilized to assess the security associated with a particular user account and/or to enable subsequent passkey authentication operations following the secure enrollment of a computing device associated with a user with a device-bound passkey.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for device-bound passkey enrollment, in accordance with some example embodiments described herein.

FIG. 4 illustrates an example flowchart for determining a first channel authentication result, in accordance with some example embodiments described herein.

FIG. 5 illustrates another example flowchart for verifying a mobile driver's license (mDL), in accordance with some example embodiments described herein.

FIG. 6 illustrates an example flowchart for verifying an image of a government-issued identifier by evaluating the similarity between an image and a government-issued identifier image, in accordance with some example embodiments described herein.

FIG. 7 illustrates an example flowchart for determining a name correspondence result, in accordance with some example embodiments described herein

FIG. 8 illustrates an example flowchart for determining a user security result, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

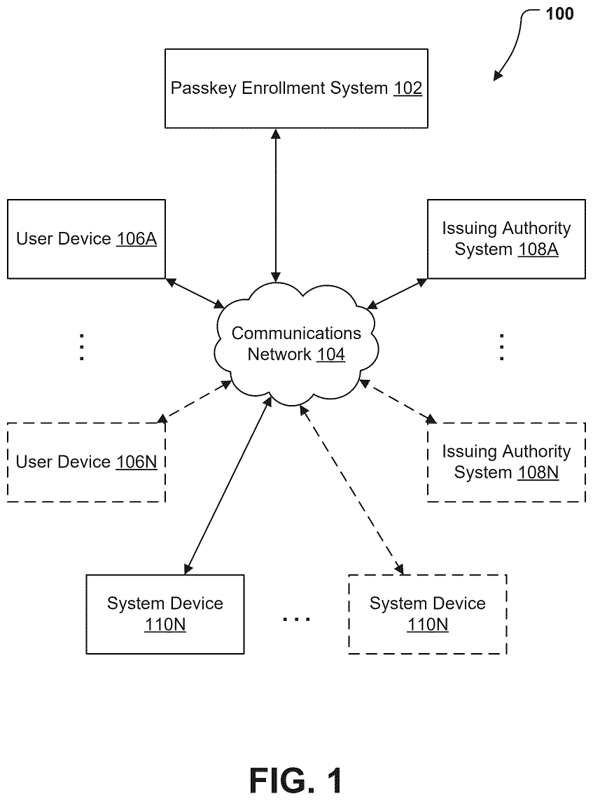

Example embodiments described herein may be implemented using any of a variety of computing devices or servers. To this end, FIG. 1 illustrates an example environment 100 within which various embodiments may operate. As illustrated, a passkey enrollment system 102 may receive and/or transmit information via communications network 104 (e.g., the Internet) with any number of other devices, such as one or more of user devices 106A-106N, system devices 110A-110N, and/or issuing authority systems 108A-108N.

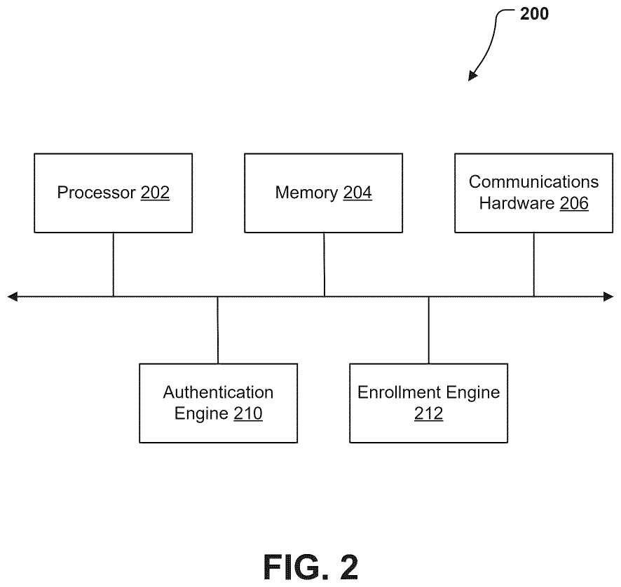

The passkey enrollment system 102 may be implemented as one or more computing devices or servers, which may be composed of a series of components. Particular components of the passkey enrollment system 102 are described in greater detail below with reference to apparatus 200 in connection with FIG. 2.

The one or more user devices 106A-106N, the one or more system devices 110A-110N, and the one or more issuing authority (IA) systems 108A-108N may be embodied by any computing devices known in the art. In some embodiments, a particular user may be associated with the one or more user devices 106A-106N. In some embodiments, system devices 110A-110N may be affiliated with the passkey enrollment system 102. For example, a system device may be an interactive voice response (IVR) system, a user device of an agent affiliated with the passkey enrollment system, or the like. In some embodiments, the one or more system devices 110A-110N may communicate over a private network, such as an intranet. An IA may be an entity that is legally entitled (or otherwise recognized as the relevant authority) to issue credentials such as driver's licenses and/or other identification cards. For example, an IA system 108A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For instance, an IA system 108A may be associated with a branch of the Department of Motor Vehicles (DMV) within a particular state in the United States (e.g., North Carolina) that is legally entitled to issue credentials (e.g., mobile driver's licenses (mDLs), driver's licenses, state identification cards) to individuals residing in that particular state. The one or more user devices 106A-106N, the one or more system devices 110A-110N, and the one or more issuing authority systems 108A-108N need not themselves be independent devices, but may be peripheral devices communicatively coupled to other computing devices.

Although FIG. 1 illustrates an environment and implementation in which the passkey enrollment system 102 interacts indirectly with a user via one or more of user devices 106A-106N, in some embodiments users may directly interact with the passkey enrollment system 102 (e.g., via communications hardware of the passkey enrollment system 102), in which case a separate user device 106A-106N may not be utilized. Whether by way of direct interaction or indirect interaction via another device, a user may communicate with, operate, control, modify, or otherwise interact with the passkey enrollment system 102 to perform the various functions and achieve the various benefits described herein.

### Example Implementing Apparatuses

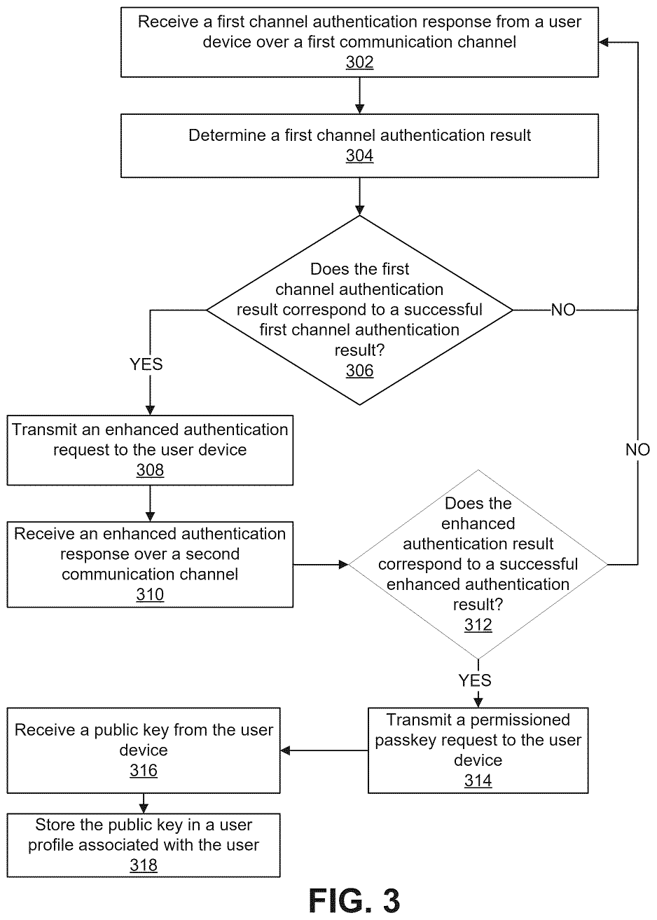

The passkey enrollment system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-8. As illustrated in FIG. 2, the apparatus 200 may include processor 202, memory 204, communications hardware 206, authentication engine 210, and enrollment engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an authentication engine 210 that determines an enhanced authentication result. The authentication engine 210 may also generate an enhanced authentication link and establish an authenticated session with the user device. In some embodiments, the authentication engine 210 may leverage one or more scoring models (e.g., a machine learning model(s) trained to determine a numerical score indicating a similarity or prediction based on input parameters) to determine inferred similarity scores, security scores, an enhanced authentication result, or the like. The authentication engine 210 may utilize processor 202, memory 204, or any other hardware component included in the apparatus 200 to perform these operations, as described in connection with FIGS. 3 and 5-8 below. The authentication engine 210 may further utilize communications hardware 206 to gather data from a variety of sources (e.g., user devices 106A-106N or IA systems 108A-108N, as shown in FIG. 1), and/or exchange data with a user, and in some embodiments may utilize processor 202 and/or memory 204.

Further, the apparatus 200 further comprises an enrollment engine 212 that stores the public key in a user profile associated with the user. The enrollment engine 212 may utilize processor 202, memory 204, or any other hardware component included in the apparatus 200 to perform these operations, as described in connection with FIG. 3 below. The enrollment engine 212 may further utilize communications hardware 206 to gather data from a variety of sources (e.g., user devices 106A-106N or IA systems 108A-108N, as shown in FIG. 1), and/or exchange data with a user, and in some embodiments may utilize processor 202 and/or memory 204.

Although components 202-212 are described in part using functional language, it will be understood that the particular implementations necessarily include the use of particular hardware. It should also be understood that certain of these components 202-212 may include similar or common hardware. For example, the authentication engine 210 and enrollment engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the authentication engine 210 and enrollment engine 212 may leverage processor 202, memory 204, or communications hardware 206 as described above, it will be understood that any of authentication engine 210 and enrollment engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication engine 210 and enrollment engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3-8, example flowcharts are illustrated that contain example operations implemented by example embodiments described herein. The operations illustrated in FIGS. 3-8 may, for example, be performed by the passkey enrollment system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, authentication engine 210, and enrollment engine 212, and/or any combination thereof. It will be understood that user interaction with the passkey enrollment system 102 may occur directly via communications hardware 206, or may instead be facilitated by a separate computing device (e.g., user device 106A or the like), as shown in FIG. 1, and which may have similar or equivalent physical componentry facilitating such user interaction.

Turning first to FIG. 3, example operations are shown for device-bound passkey enrollment.

As shown by operation 302, the apparatus 200 includes means, such as memory 204, communications hardware 206, or the like, for receiving a first channel authentication response from a user device over a first communication channel. The first channel authentication response may be an electronic response that includes call data associated with an active call between a user device, such as user device 106A and a system device, such as system device 110A. In some embodiments, communications hardware 206 may be configured to receive a first channel authentication response from the system device 110. The first authentication response may include call data that pertains to a call with the user over a first communication channel. A first communication channel may be an audio channel. In some embodiments, a first communication channel is facilitated over a public switched telephone network (PSTN), cellular network, voice over internet protocol (VoIP), a hybrid system, and/or the like.

In some embodiments, the system device 110A may be an interactive voice response (IVR) system, a user device of an agent, or the like. The user may use user device 106A to call a system device 110A over the first communication channel and during the call, may indicate he/she would like to configure his/her user account with a passkey. For example, the user may navigate through an IVR menu and select a “passkey enrollment option”. Alternatively, the user may indicate to an agent on the call that he/she would like to use a passkey for authentication. In response to this indication, the system device 110A may provide a first channel authentication request to the communications hardware 206. In some embodiments, the system device 110A may provide the first channel authentication request to communications hardware 206 over a private intranet network. In turn, the communications hardware 206 may provide the first channel authentication request to the authentication engine 210.

The first channel authentication request may include call data pertaining to the call with the user received over the first communication channel. The call data may include information (e.g., numeric information, alphanumeric information, audio information, or the like) that was collected from the user (e.g., via user input of a computing device associated with the user) during an active call over the first communication channel. For example, the call data may include an indication of a particular service that the user associated with the active call requests (e.g., device-bound passkey enrollment) and/or authentication data associated with the user, such as a password, a PIN, or the like that was input by the user over the first communication channel. In some embodiments, the included authentication data may correspond to a particular requested service. For example, an IVR menu may be configured to request one or more authentication factors from a user in response to a user selecting performance of a particular service (e.g., device-bound passkey enrollment). Additionally, the call data may include a purported user identifier that indicates a particular user that the user associated with the first channel authentication response alleges they are. For example, the first channel authentication response may include an account number, user identifier (ID), a first and/or last name, or the like, that may ultimately be utilized to identify a particular purported user. In some embodiments, the call data in the first channel authentication response is formatted as audio data.

In some embodiments, upon receiving the first channel authentication response, communications hardware 206 may subsequently store the passkey enrollment request in a local storage device (e.g., memory 204, or the like). For example, the first channel authentication response may be stored in a user profile (stored in memory 204) associated with the purported user of which the passkey enrollment request corresponds.

As shown by operation 304, the apparatus 200 includes means, such as memory 204, authentication engine 210, or the like, for determining a first channel authentication result. The first channel authentication result may indicate whether a user (e.g., the user associated with the user device that provided the first channel authentication response in operation 302) is authenticated or not authenticated (e.g., verified or not verified based on a similarity between the received authentication data and baseline authentication data that is stored in a local storage device, such as memory 204). For example, a user authentication result may be a categorical value of “authenticated” or “not authenticated”, a numerical value of 1 for an authenticated user or 0 for a non-authenticated user, a Boolean value of “true” for an authenticated user or “false” for a non-authenticated user, or the like. A first channel authentication result that corresponds to an authenticated user may indicate that there is a sufficient likelihood that the user associated with the first channel authentication response is who they allege they are. That is, the user on the call over the first communication channel is determined to likely correspond to a user associated with a user account to which the call pertains. Alternatively, a user authentication result that corresponds to a non-authenticated user may indicate that there is an insufficient likelihood that the user associated with the first channel authentication response is who they allege they are.

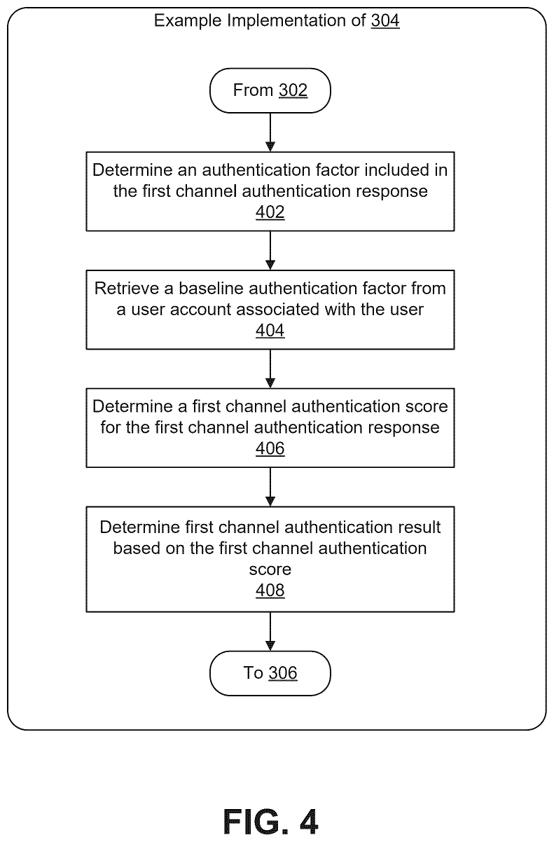

In some embodiments, authentication engine 210 may utilize the received first channel authentication response to determine a first channel authentication result. Determining the first channel authentication result is discussed in greater detail below in relation to FIG. 4.

Turning now to FIG. 4, example operations are shown for determining a first channel authentication result.

As shown by operation 402, the apparatus 200 includes means, such as authentication engine 210 or the like for determining an authentication factor included in the first channel authentication response. The determined authentication factor may be associated with an authentication factor type, which indicates the authentication factor included in the first channel authentication response. For example, an authentication factor type may be a PIN authentication factor type, password authentication factor type, or the like.

In some embodiments, authentication engine 210 may use any suitable method to determine (e.g., recognize) an authentication factor that is included in the first channel authentication response. For example, assuming the first channel authentication response includes a numeric input, authentication engine 210 may parse the first channel authentication response and compare the parsed components of the first channel authentication response to expected patterns. In some embodiments, the authentication engine 210 may identify a user prompt for authentication factor information and determine a corresponding authentication factor associated with the user prompt.

In some embodiments, to identify the user prompt for an authentication factor, the authentication engine 210 may use speech-to-text techniques to convert received audio to text. The authentication engine 210 may then process the text using natural language processing techniques (NLP) to identify user prompts of interest. A user prompt of interest may correspond to a user prompt provided by the system device 110A that requests the user to provide an authentication factor. For example, a user prompt of interest may be a request for a user PIN. A particular user prompt may correspond to an authentication factor type. By way of continuing example, a user prompt for a user PIN may correspond to a user PIN authentication factor type.

In some embodiments, the authentication engine 210 may determine a corresponding authentication factor based on a user provided response to the prompt. In some embodiments, the authentication factor may similarly use NLP techniques to determine an authentication factor to a user response. By way of continuing example, the authentication engine 210 may process a verbal audio response to the prompt and identify only the sequential numbers provided by the user. If the user used the dial keys of user device 106A to provide a user response, the authentication engine may be configured to use a dual-tone multi-frequency (DTMF) decoder to decode the frequency of the audio or analog signal sent by the user device. This allows the authentication engine 210 to determine the numbers entered by the user. In some embodiments, the system device 110A may perform this decoding step using its DTMF decoder. The call data may include the decoded audio tones as numerical values, or if applicable corresponding one-hot encoded or categorical values.

The determined authentication factor may further correspond to an authentication factor type. The authentication factor type for an authentication factor may be determined based on the associated user prompt. By way of continuing example, the user prompt for a user PIN may correspond to a user PIN authentication factor type and thus, the corresponding authentication factor that includes digits of the user input PIN may correspond to the PIN authentication factor type.

As shown by operation 404, the apparatus 200 includes means, such as memory 204, authentication engine 210, or the like, for retrieving a baseline authentication factor from a user profile associated with the user. In some embodiments, a local storage device, such as memory 204, may store baseline authentication data for each user. For example, baseline authentication data for each user may be stored in a corresponding user profile. In some embodiments, the stored baseline authentication data may store each baseline authentication factor and its corresponding authentication factor type in the form of key-value pairs where the key is the baseline authentication factor, and the value is the baseline authentication factor type. In this regard, authentication engine 210 may utilize the baseline authentication factor data to retrieve a corresponding baseline authentication factor of the same authentication factor type as the authentication factor that is included in the first channel authentication response.

As shown by operation 406, the apparatus 200 includes means, such as memory 204, authentication engine 210, or the like for determining a first channel authentication score for the first channel authentication response. The first channel authentication score may be a numerical score (e.g., a value between 0 and 1) that indicates the likelihood that a purported user on the call is the user associated with the user account. In some embodiments, the first channel authentication score may be based on a comparison between the authentication factor included in the first channel authentication response and the corresponding retrieved baseline authentication factor. Authentication engine 210 may utilize a first channel authentication factor evaluation set, which may be stored in a local storage device (e.g., memory 204), to determine a first channel authentication score. The first channel authentication factor evaluation set may describe particular rules and/or conditions that authentication engine 210 may utilize to determine how to evaluate each received authentication factor (e.g., the authentication factor evaluation set may describe a weight for each authentication factor, a similarity threshold to utilize while evaluating a particular authentication factor, or the like). For example, the authentication factor evaluation set may describe that a PIN authentication factor type must exactly match a baseline authentication factor to receive a first channel authentication factor score of 1 otherwise the PIN authentication factor may be associated with an authentication factor score of 0.

In some embodiments, if the first channel authentication response includes multiple authentication factors, each of which corresponding to a different authentication factor type, the authentication engine 210 may utilize the authenticating factor evaluation set to determine a partial authentication score for each received authentication factor. In some embodiments, authentication engine 210 may use any suitable method to combine the partial authentication score for each received authentication factor. For example, authentication engine 210 may calculate a weighted average of partial authentication scores where each authentication factor is weighted based on a weight that is indicated by the authentication factor evaluation set. Alternatively, authentication engine 210 may leverage a trained machine learning model to combine each partial authentication result to ultimately determine a first channel authentication score for the first channel authentication response. For example, the machine learning model may be trained using a large training dataset comprising first channel authentication responses, which in turn comprise authentic and nonauthentic authentication factors that correspond to partial authentication scores. As a result, the machine learning model may learn weights for each authentication factor type, and thus may utilize these learned weights to combine the partial authentication scores that are determined for each received authentication factor type.

As shown by operation 408, the apparatus 200 includes means, such as memory 204, authentication engine 210, or the like for determining a first channel authentication result based on the first channel authentication score. Once the authentication engine 210 has determined the first channel authentication score, the authentication engine 210 may determine the first channel authentication result. In some embodiments, the authentication engine 210 may compare the first channel authentication score to one or more first channel authentication score thresholds. If the first channel authentication score satisfies the one or more first channel authentication score thresholds, the authentication engine may determine a first channel authentication result indicative that the user is successfully authenticated. If the first channel authentication score fails to satisfy a first channel authentication score threshold, the authentication engine may determine a first channel authentication result indicative that the user is not authenticated.

Returning to FIG. 3, as shown by operation 306, the apparatus 200 includes means, such as authentication engine 210 or the like, for determining whether the first channel authentication result corresponds to a successful first channel authentication result. The authentication engine 210 may determine a successful first channel authentication result if the first channel authentication result is indicative that the user was successfully authenticated. The authentication engine 210 may determine an unsuccessful first channel authentication result if the first channel authentication result is indicative that the user failed to be successfully authenticated.

In response to determining a successful first channel authentication result, the process may advance to operation 308. Alternatively, if a successful first channel authentication result is not determined (e.g., an unsuccessful result is determined), the authentication engine 210 may proceed back to operation 302. This may cause the communications hardware 206 to request system device 110A re-prompt the user for authentication factors. The user may be allowed a threshold number of reattempts. If the first channel authentication result remains unsuccessful, the authentication engine 210 may flag the user account for potential fraud. In some embodiments, the authentication engine 210 may use communications hardware 206 to cause the system device 110A to disconnect the call with user device 106A.

As shown by operation 308, the apparatus 200 includes means, such as communications hardware 206, authentication engine 210, or the like, for transmitting an enhanced authentication request to the user device. The enhanced authentication request may be an electronic request that prompts a user (e.g., a user associated with a computing device, such as user device 106A) to provide enhanced authentication data (e.g., authentication data in addition to the authentication data that was provided to the apparatus 200 in operation 302) to the apparatus 200 over a second communication channel. The second communication channel may be different than the first communication channel. In some embodiments, the second communication channel is a digital channel. For example, the second communication channel may be the internet (e.g., using hypertext transfer protocols (HTTP) or HTTP secure (HTTPS) protocols), application programming interfaces (APIs), a mobile application or software application, short message service (SMS) messages, Bluetooth, near-field communication (NFC), and/or the like.

In some embodiments, the enhanced authentication request may refer to a request for additional authentication factors. In some embodiments, the use the second communication channel may enable a user device to provide additional authentication factors that cannot be provided over the first communication channel. For example, the enhanced authentication request may be a request for a government issued identifier (e.g., a mobile driver's license (mDL), driver's license, passport, or the like).

In some embodiments, the enhanced authentication request may include an enhanced authentication link. The enhanced authentication link may be a link that directs the user to an endpoint within a mobile application or web browser. For example, the enhanced authentication link may direct a user to a mobile application logon page that is associated with the entity that is providing the secure device-bound passkey enrollment service provided by the passkey enrollment system 102. In some embodiments, the enhanced authentication link may be uniquely generated for a particular passkey enrollment request. For example, upon a successful verification of the first authentication response, authentication engine 210 may generate a unique enhanced authentication link by generating the enhanced authentication link for a particular endpoint based on a uniquely generated token. In this regard, authentication engine 210 may utilize data included in a user profile associated with the user (e.g., user profile data), such as a user ID, time stamp of the received first authentication response, nonce (e.g., a randomly generated value that ensures the uniqueness (e.g., randomness) of the generated token), a predefined expiration time (e.g., five minutes), and/or the like, to generate the token.

Upon generation of the randomly generated token, authentication engine 210 may store the randomly generated token in a local storage device, such as memory 204, and include the randomly generated token in the enhanced authentication request. For example, the randomly generated token may be stored in a corresponding user profile (e.g., a user profile associated with the user that transmitted the first authentication response.

Authentication engine 210 may generate a unique link that points to the endpoint of a web browser or mobile application associated with the entity that is providing the passkey enrollment system provided by passkey enrollment system 102 by appending the uniquely generated token (e.g., to be utilized as a query parameter) to the link that points to the above-described endpoint of a mobile application or web browser. In some embodiments, upon generating (e.g., via authentication engine 210) the unique link and including the unique link in an enhanced authentication request, authentication engine 210 may leverage communications hardware 206 to transmit the enhanced authentication request to a corresponding user device (e.g., user device 106A or the like that is associated with the user logon request) via a network (e.g., communications network 104, shown in FIG. 1).

In some embodiments, if a user interacts with (e.g., clicks) the enhanced authentication link on a user device (e.g., user device 106A, or the like), the user device may be directed to and open an endpoint of a mobile application that may in turn extract the token from the URL and send the token to authentication engine 210 (e.g., via a network, such as communications network 104, shown in FIG. 1). Authentication engine 210 may then compare the received token to the stored token in the corresponding user profile for verification. For example, authentication engine 210 may split the token into its components, such as user ID, timestamp, nonce, expiration time/date, or the like, and may recompute the token. In this regard, if the computed token matches the received token, authentication engine 210 may successfully verify the received token, and thus may allow the user device to access the endpoint. Alternatively, if the tokens do not match, authentication engine 210 may deny the user device access to the endpoint.

In some embodiments, once the user device is granted access to the endpoint (e.g., an endpoint within a mobile application), the apparatus 200 (e.g., communications hardware 206) may receive a user logon request. The user logon request may be an electronic logon request that includes user account authentication data. For example, the user logon request may include a username and password associated with a particular user account. Authentication engine 210 may compare the received username and password to a ground truth username and password associated with the particular user account. For example, the ground truth username and password may be included in a user profile associated with the user (e.g., a user profile stored in memory 204, or the like). As such, authentication engine 210 may determine whether the received username and password (e.g., received in the user logon request) match the username and password included in the user profile. In some embodiments, authentication engine 210 may deny access to the mobile application if the received username and password (e.g., received in the user logon request) does not match the username and password included (e.g., stored) in the corresponding user profile.

Alternatively, authentication engine 210 may grant access to the mobile application if the received username and password (e.g., received in the user logon request) match the username and password included in the user profile. In such an embodiment, authentication engine 210 may establish an authenticated session with the user device that interacted with the enhanced authentication link. An authenticated session with the user may describe a period of time where the user associated with the user logon request is authentication (e.g., via the successful verification of a username and password). In some embodiments, authentication engine 210 may use any suitable method to generate a session token (e.g., a JSON Web Token (JWT)). For example, authentication engine 210 may (i) create a header that comprises metadata about the token (e.g., JWT, a signing algorithm, such as Hash-based Message Authentication Code (HMAC) with SHA-256, and/or the like), (ii) create a payload that comprises user data and/or token data (e.g., information about the user, such as a user identifier, and expiration time for the token, or the like), (iii) encode and combine the header and payload, such that the data may be securely utilized in uniform resource locators (URLs), and (iv) the combined header and payload may be signed using a secret key and signing algorithm, such that the signing creates a unique key based on the secret key and singing algorithm.

In response to the generation of the session token, authentication engine 210 may leverage communications hardware 206 to cause transmission of the session token to the user device that corresponds with the received user logon request. For example, authentication engine 210, may leverage communications hardware 206 to cause transmission of the generated session token to user device 106A via communications network 104, shown in FIG. 1. The transmission of the generated session token to a computing device may enable the passkey enrollment system 102 to validate the token before granting the computing device access to particular resources, such as a user portal to upload (e.g., transmit) enhanced authentication data. To this end, establishing an authenticated session with a user before receiving enhanced authentication data increases security because a tampered token would invalidate the generated signature, and thus cause termination of the authenticated session, which would in turn prohibit the transmission of enhanced authentication data to the apparatus 200 (e.g., communications hardware 206). In this regard, requiring the establishment of an authenticated session before a user may submit enhanced authentication data increases security by ensuring, based on the generated token's integrity, that only legitimate (e.g., authorized) users can submit enhanced authentication data.

As shown by operation 310, the apparatus 200 includes means, such as memory 204, communications hardware 206, or the like, for receiving an enhanced authentication response over a second communication channel. The enhanced authentication response may be an electronic response that includes enhanced authentication data (e.g., an indication of a government issued identifier, an image of a user, or the like). In some embodiments, the enhanced authentication data may be received during an established authenticated session (e.g., the authenticated session established in operation 308).

In some embodiments, the enhanced authentication response may be received over a second communication channel that is different from the first communication channel (e.g., a telephone network, VoIP network, or the like). In this regard, the second communication channel maybe a pathway or mechanism through which the enhanced authentication response is received by the apparatus 200 (e.g., communications hardware 206) that is not a telephone network, VoIP network, or the like, such as via an internet connection using internet protocols (e.g., HTTP/HTTPS), Bluetooth or Near-Field Communication (NFC), or the like. For example, communications hardware 206 may receive the enhanced authentication request from user device 106A over the internet (e.g., communications network 104, shown in FIG. 1). In some embodiments, upon receiving the enhanced authentication response, communications hardware 206 may store the enhanced authentication response in a local storage device, such as memory 204 (e.g., the received enhanced authentication response may be stored in the corresponding user profile to which the enhanced authentication response corresponds). Additionally or alternatively, communications hardware 206 may immediately transmit the received enhance authentication response to authentication engine 210, such that authentication engine 210 may promptly evaluate the enhanced authentication response.

As shown by operation 312, the apparatus 200 includes means, such as memory 204, authentication engine 210, or the like, for determining an enhanced authentication result. The enhanced authentication result may indicate whether the user that transmitted the enhanced authentication response is successfully or unsuccessfully authenticated based on based on a similarity between the received authentication data and baseline authentication data. For example, an enhanced authentication result may be a categorical value of “authenticated” or “not authenticated”, a numerical value of 1 for an authenticated user or 0 for a non-authenticated user, a Boolean value of “true” for an authenticated user or “false” for a non-authenticated user, or the like. An enhanced authentication result that corresponds to an authenticated user may indicate that there is a sufficient likelihood that the user that transmitted the enhanced authentication response from a computing device (e.g., user device 106A, or the like) is who they allege they are. Alternatively, an enhanced authentication result that corresponds to a non-authenticated user may indicate that there is an insufficient likelihood that the user that transmitted the enhanced authentication response from a computing device is who they allege they are.

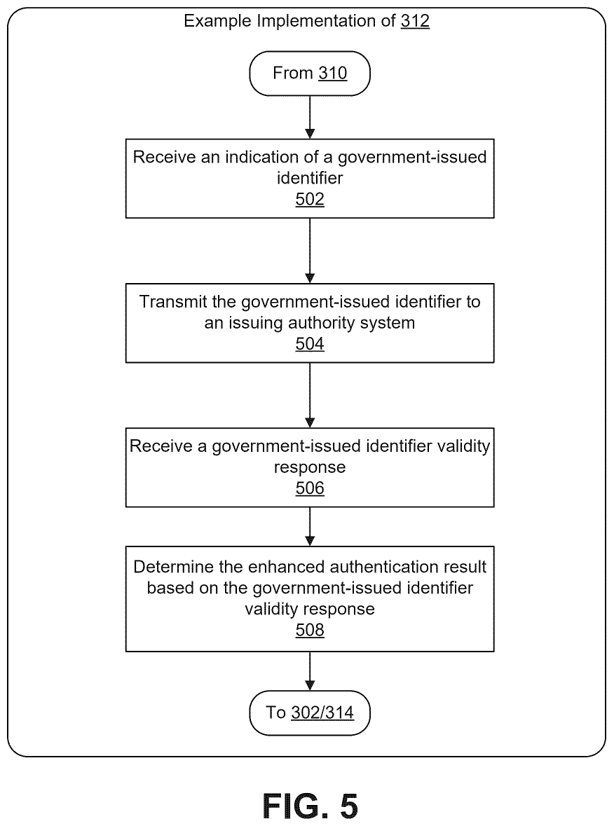

In some embodiments, the enhanced authentication result may be based on a variety of different data elements included or derived from the enhanced authentication response. For example, the enhanced authentication result may be based on a verification result associated with an indication of a government-issued identifier, a security score based on metadata associated with the enhanced authentication request, an image verification result indicating the similarity between a received image of a user and the image in a government-issued identifier, or the like. In some embodiments, authentication engine 210 may leverage an enhanced authentication model to determine an enhanced authentication result. The enhanced authentication model may be a machine learning model that may be trained to combine a variety of different inputs features (e.g., a security result, a government-issued identifier verification result, an image verification result, and/or the like) to ultimately determine an enhanced authentication result. As a result, authentication engine 210 may provide one or more features to the enhanced authentication model and subsequently store the output enhanced authentication result in a corresponding user profile (e.g., a user profile associated with the user that transmitted the enhanced authentication response via a corresponding user device, such as user device 106A). The determination of the one or more features (e.g., by authentication engine 210) that may be provided to the enhanced authentication model to ultimately determine the enhanced authentication result is described in greater detail below in relation to FIGS. 5-8.

Turning now to FIG. 5, example operations are shown for verifying a mobile driver's license.

As shown by operation 502, the apparatus 200 includes means, such as memory 204, communications hardware 206, or the like, for receiving an indication of a mobile driver's license (mDL). A mDL may refer to various mobile (e.g., digital) identity credential types associated with a respective user including mobile driver's licenses and mobile identification cards. In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA).

An mDL may be issued (e.g., provisioned) to a respective user by an IA system 108A associated with a particular IA. An IA may be an entity that is legally entitled (or otherwise recognized as the relevant authority) to issue credentials such as driver's licenses and/or other identification cards. An IA system 108A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 108A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally, or alternatively, in some embodiments, an mDL may be administered, managed, employed, and/or otherwise utilized by the passkey enrollment system 102 in compliance with various standards set forth by the American Association of Motor Vehicle Administrators (AAMVA). Additionally, or alternatively, in some embodiments, an mDL may be administered, managed, employed, and/or otherwise utilized by the passkey enrollment system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 108A and one or more portions of credential data related to the mDL may be retrieved in real time, or near-real time, during a operation e.g., a delegated task) performed by the user. Additionally, or alternatively, once an mDL is issued to a user by a respective IA (e.g., by way of a corresponding IA system 108A), the mDL may be stored locally on a user device associated with the user (e.g., user device 106A) such that the mDL may be used without relying on a communications network (e.g., communications network 104).

In some examples, an IA may provision an mDL to a particular user device (e.g., user device 106A) associated with a user such that the mDL is associated with various user device identification data related to the particular user device (e.g., cryptographical identification data such as a public key). This may ensure that an mDL associated with a respective user cannot be transferred to multiple devices without authorization by the IA system (e.g., IA system 108A) and used in fraudulent transactions. Furthermore, associating an mDL with a particular user device (e.g., user device 106A) also enables the passkey enrollment system 102 and/or an IA system of an IA (e.g., IA system 108A) to verify that the intended user of the mDL is in possession of the mDL. Further still, associating an mDL with a particular user device (e.g., user device 106A) also ensures the safe transfer of sensitive credential data to and/or from the intended user of the mDL.

An mDL may be associated with various mDL data security mechanisms used to ensure the validity of the mDL, authenticate an originating IA that issued the mDL, protect a user's personal data, and/or facilitate secure mDL-based operations (e.g., authentication operations). In this regard, an mDL may be associated with a mobile security object (MSO) and/or various public and private cryptographic key information. An MSO is an electronically managed data structure that enables the authentication of the accuracy and origin of various credential data associated with the mDL during mDL-based operations. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various operations. For example, if the credential data associated with the MSO indicates that the mDL is expired, the corresponding user may not be permitted to engage in one or more operations (e.g., delegated tasks) using the mDL.

In some embodiments, an indication of a government-issued identifier may refer to a quick-response (QR) code, such that the QR code includes information associated with the government-issued identifier. In such an embodiment, the indication of a government-issued identifier, such as an QR code associated with a mDL, may point to various credential data associated with the IA that provisioned the mDL and various credential data associated with a respective user.

As shown by operation 504, the apparatus 200 includes means, such as memory 204, communications hardware 206, or the like, for transmitting the indication of the mDL to an issuing authority (IA) system (e.g., IA system 108A, IA system 108N, or the like). An IA system may be a computing device associated with an issuing authority that provisioned the mDL. In some embodiments, authentication engine 210 may generate a digital token comprising cryptographic information associated with the mDL. In this regard, the generated token may be transmitted (e.g., by communications hardware 206 and via a network, such as communications network 104) to a corresponding IA system (e.g., IA system 108A). In some embodiments, the generated token may comprise one or more of cryptographical information associated with the mDL, cryptographical information associated with a user device in which the mDL corresponds or was transmitted from, desired credential data associated with the mDL, location data, user profile data, or user account data. In some embodiments, authentication engine 210 may use any suitable method, such as using a JWT token creation technique, or the like, to generate the digital token. In some embodiments, authentication engine 210 may generate a digital token comprising cryptographic information (e.g., publish key information) associated with the indication of the mDL included in the enhanced authentication request.

In some embodiments, the indication of the mDL may include an indication of the IA system (e.g., IA system 108A, or the like) associated with the IA that provisioned the mDL. As a result, authentication engine 210 may leverage communications hardware 206 to transmit the digital token associated with the received indication of the government-issued identifier to the correct IA. In particular, authentication engine 210 may leverage communications hardware 206 to transmit the digital token to an IA system that provisioned the government-issued identifier, such that the IA system may decrypt the cryptographic information comprised in the digital token. In this manner, the IA system may e.g., verify one or more portions of credential data associated with the mDL.

As shown by operation 506, the apparatus 200 includes means, such as memory 204, communications hardware 206, or the like, for receiving a government-issued identity validity response. The government-issued identity validity response may indicate whether the token generated based on the indication of the mDL (e.g., the token generated in operation 504) corresponds to verified credential data. In some examples, the government-issued identity validity response may be a categorical value of “verified” or “not verified”, a numerical value of 1 for a verified mDL or 0 for non-verified mDL, a Boolean value of “true” for a verified mDL or “false” for a non-verified mDL, etc.

In some embodiments, communications hardware 206 may receive the government-issued identity validity response from the IA system (e.g., IA system 108A, or the like) that provisioned the government-issued identifier via a network (e.g., communications network 104, shown in FIG. 1). Upon receiving the government-issued identity validity response, communications hardware 206 may store the government-issued identity validity response in a local storage device (e.g., memory 204, or the like). In this regard, the government-issued identity validity response may be stored in the user profile that corresponds to the user associated with the government-issued identifier. Additionally or alternatively, communications hardware 206 may immediately transmit the government-issued identity validity response to authentication engine 210, such that authentication engine 210 may utilize the government-issued identity validity response (e.g., by providing the government-issued identity validity response to a machine learning model that is trained to determine the enhanced authentication result) to ultimately determine whether the enhanced authentication result corresponds to a successful enhanced authentication result.

As shown by operation 508, the apparatus 200 includes means, such as memory 204, authentication engine 210, or the like, for determining the enhanced authentication result based on the government-issued identifier validity response. As discussed above in relation to operation 312, the enhanced authentication result may indicate whether the user that transmitted the enhanced authentication response is successfully or unsuccessfully authentication and may be based on a variety of different data elements included or derived from the enhanced authentication response. In some embodiments, the government-issued validity response may be provided to a machine learning model (e.g., the enhanced authentication model) that may be trained to combine a variety of different input features (e.g., a security result, a government-issued identifier verification result, an image verification result, and/or the like) to ultimately determine an enhanced authentication result. In this regard, authentication engine 210 may retrieve the government-issued identifier validity response from a local storage device (e.g., memory 204, or the like) and subsequently may provide the government-issued identifier validity response to the enhanced authentication model to allow the enhanced authentication model to produce the enhanced authentication result based on the government-issued identifier validity response.

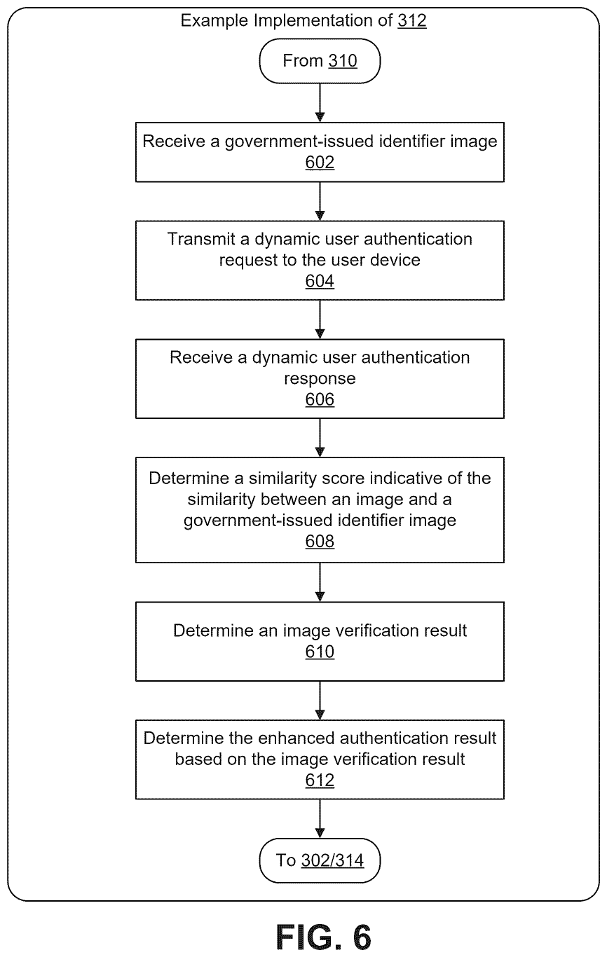

Turning now to FIG. 6, example operations are shown for verifying an image of a government-issued identifier by evaluating the similarity between an image and a government-issued identifier image.

As shown by operation 602, the apparatus 200 includes means, such as memory 204, communications hardware 206, or the like, for receiving a government-issued identifier image. A government-issued identifier image may refer to an image of an official document that was generated by a government agency that may be used to uniquely identify an individual. For example, a government-issued identifier image may refer to an image of a passport, driver's license, identification card, or the like. For example, the government-issued identifier image may depict a unique identification number associated with the user (e.g., a driver's license number, passport number, or the like), a name of the user to which the government-issued identifier corresponds, watermarks, or the like. In some embodiments, the government-issued identifier image may be received by the apparatus 200 (e.g., communications hardware 206) over a network (e.g., communications network 104, shown in FIG. 1) from the computing device (e.g., user device 106A, or the like) that received the enhanced authentication request.

In some embodiments, the government-issued identifier image may be included in the enhanced authentication response (e.g., described in relation to operation 310). Alternatively, the government-issued identifier may be received separately from the enhanced authentication request. For example, the government-issued identifier image may be received during a user account set up, and thus may be stored in association with user in which the government-issued identifier image corresponds (e.g., the government-issued identifier image may be stored in a user profile associated with the user).

As shown by operation 604, the apparatus 200 includes means, such as communications hardware 206, or the like, for transmitting a dynamic user authentication request to the user device. In some embodiments, the dynamic user authentication request may be an electronic request that requests a user to capture an image of themselves and provided the captured image to the apparatus 200 to allow the apparatus 200 to compare the captured image of themselves to the government-issued identifier image. For example, the dynamic user authentication request may include a link that points to a web browser or mobile application associated with the entity that is providing the passkey enrollment system provided by passkey enrollment system 102. In some embodiments, the particular endpoint included in the dynamic user authentication request may point to a particular portal embedded in a web browser or mobile application where the user may provide a current (e.g., an image captured from user device 106A) image of themselves to the apparatus 200. Alternatively, the endpoint embedded in the dynamic user authentication request may be included in the enhanced authentication request (e.g., as a separate link or included in the enhanced authentication link).

As shown by operation 606, the apparatus 200 includes means, such as memory 204, communications hardware 206, or the like, for receiving a dynamic user authentication response. The dynamic user authentication response may refer to an electronic response that includes an image of the user that was captured via a camera on a computing device associated with the user. In some embodiments, the dynamic user authentication response may be included in the enhanced authentication response. Alternatively, the dynamic user authentication response may be received separately from the enhanced authentication response. The image of the user may be a current (e.g., live) image of the user that is captured via a particular endpoint of a mobile application or web browser. For example, the dynamic user authentication response may be received by communications hardware 206 via a network (e.g., communications network 104, shown in FIG. 1) from the computing device (e.g., user device 106A) that received the dynamic authentication request. Upon receiving the dynamic user authentication response, communications hardware 206 may store the received dynamic user authentication response (e.g., a captured image of the user) in the user profile associated with the user in which the dynamic user authentication response corresponds. Additionally or alternatively, communications hardware 206 may immediately transmit the dynamic user authentication response to authentication engine 210, such that authentication engine 210 may immediately compare the image of the user and the government-issued identifier image (e.g., as described below in relation to operation 608).

As shown by operation 608, the apparatus 200 includes means, such as memory 204, authentication engine 210, or the like, for determining a similarity score indicative of an inferred similarity between an image and a government-issued identifier image. The similarity score may refer to a numerical score (e.g., a value between 0 and 1), while in other embodiments the similarity score may be converted into a categorical result (e.g., tier 1/tier 2/ tier 3, green/yellow/red, or some other categorical classification). For example, a comparison between the image and the government-issued identifier image may yield a high numerical score (e.g., 0.95), which may indicate that the image and the government-issued identifier image are similar.

In some embodiments, authentication engine 210 may leverage a similarity scoring model to determine the similarity score. In some embodiments, the similarity scoring model is a machine learning model that is configured to perform comparisons between a received image and a government-issued identifier image. In some embodiments, the similarity scoring model is a convolutional neural network (CNN) that may be trained to extract or otherwise determine one or more features from an image of the user and the government-issued identifier image where the one or more features correspond to a particular feature type (e.g., particular facial landmarks). The features may be encoded into a numerical representation (e.g., a feature vector) that the similarity scoring model may use to determine the similarity between the received image and the government-issued identifier image. The similarity scoring model may use the one or more features associated with an image of the user and the one or more features associated with the government-issued identifier and compare the one or more features of the same feature type. For example, assume the one or more features and corresponding feature types for the image of the user and the government-issued identifier are (i) left eye (120, 150), right eye (250, 150) and (ii) left eye (110, 150), right eye (245, 155). In this regard, the similarity scoring model may generate a partial similarity score based on a comparison between the same feature types (e.g., left eye or right eye). As such, in the above example, the similarity scoring model may generate two partial similarity scores that indicate left eye similarity and right eye similarity respectively. In some embodiments, each partial similarity score may be a numerical score (e.g., a score between 0 and 1), while in other embodiments the partial similarity score may be converted into a categorical result (e.g., tier 1/tier 2/ tier3, green/yellow/red, or some other categorical classification).

In some embodiments, the partial similarity score for each feature type may be combined to determine the similarity score. The similarity scoring model may use any suitable method (e.g., calculating an average, calculating a weighted average, or the like) to combine the partial similarity scores to determine the similarity score. For example, the similarity scoring model may assign weights to each partial similarity score based on the corresponding feature type associated with each partial similarity score. For example, a local storage device, such as memory 204, may store a set of partial similarity score rules that describe particular weights associated with each feature type. As such, authentication engine 210 may provide the set of partial similarity score rules to the similarity scoring model, such that the similarity scoring model may weigh each determined partial similarity scores accordingly while determining the similarity score.

Moreover, in some embodiments, the similarity scoring model may utilize any suitable image processing technique, such as noise reduction, or the like, to enhance the image of the user or image of the government-issued identifier. In addition, the similarity scoring model may use a segmentation technique to isolate the image of the user from the received current image of the user and/or the government-issued identifier image. In some embodiments, the similarity score may be stored in a corresponding user profile (e.g., a user profile associated with the user) in a local storage device (e.g., memory 204, or the like).

As shown by operation 610, the apparatus 200 includes means, such as memory 204, authentication engine 210, or the like, for determining an image verification result. The image verification result may indicate whether the image of the user and the government-issued identifier image satisfy a similarity score threshold. The similarity score threshold may be a predefined similarity score threshold. For example, the entity that is providing the secure device-bound passkey enrollment service offered by the passkey enrollment system 102 may store a predetermined similarity score threshold in a local storage device (e.g., memory 204, or the like). The predetermined similarity score threshold may describe a value or category that a similarity score must satisfy in order to produce a particular image verification result (e.g., a successful image verification result, an unsuccessful image verification result, or the like). In this regard, authentication engine 210 may retrieve the predefined similarity score threshold from a local storage device (e.g., memory 204) and subsequently compare the determined similarity score (e.g., the similarity score determined in operation 608) to a similarity score threshold to determine an image verification result. Upon determination of a particular image verification result, authentication engine 210 may store the determined image verification result in a user profile associated with the user of which the image verification result corresponds.

As shown by operation 612, the apparatus 200 includes means, such as processor 202, memory 204, authentication engine 210, or the like, for determining the enhanced authentication result based on the image verification result. As discussed above in relation to operation 312, the enhanced authentication result may indicate whether the user that transmitted the enhanced authentication response is successfully or unsuccessfully authentication and may be based on a variety of different data elements included or derived from the enhanced authentication response. In some embodiments, the image verification result may be provided to a machine learning model (e.g., the enhanced authentication model) that may be trained to combine a variety of different input features (e.g., a security result, a government-issued identifier verification result, an image verification result, and/or the like) to ultimately determine an enhanced authentication result. In this regard, authentication engine 210 may retrieve the image verification result from a local storage device (e.g., memory 204, or the like) and subsequently may provide the image verification result to the enhanced authentication model to allow the enhanced authentication model to produce the enhanced authentication result based on the image verification result.

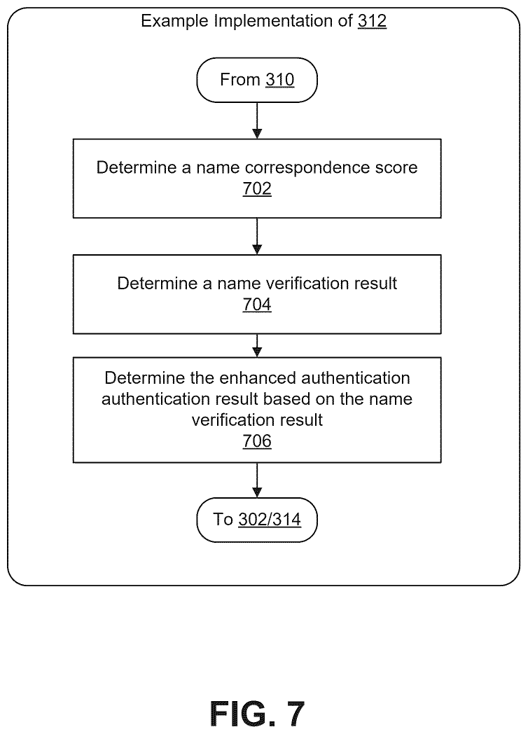

Turning now to FIG. 7, example operations are shown for determining a name correspondence result.

As shown by operation 702, the apparatus 200 includes means, such as memory 204, authentication engine 210, or the like, for determining a name correspondence score. The name correspondence score may indicate whether a name depicted in a government-issued identifier image corresponds to a stored name in a user profile associated with a user. In some embodiments, the name correspondence score may refer to a numerical score (e.g., a value between 0 and 1), while in other embodiments the name correspondence score may be converted into a categorical result (e.g., tier 1/tier 2/ tier 3, green/yellow/red, or some other categorical classification). For example, a comparison between the name illustrated in the government-issued identifier image and the name stored in a user profile (that is in turn, stored in a local storage device, such as memory 204) may yield a high numerical score (e.g., 0.96), which may indicate that the stored name in a user profile and the name depicted in a government-issued identifier image are similar.

In some embodiments, authentication engine 210 may perform any suitable image preprocessing technique to enable the authentication engine 210 to accurately determine a name correspondence score. For example, authentication engine 210 may reduce the noise in the received government-issued identifier image by filtering out shadows, glares, or the like, to improve image clarity so that the image of the government-issued identifier clearly depicts the name depicted in the government-issued identifier image. In another example, authentication engine 210 may convert the image to a black and white image by (i) extracting the RGB values associated with the government-issued identifier image (e.g., via corresponding pixel data associated with the government-issued identifier image) and (ii) applying a grayscale conversion formula to each pixel. In yet another example, authentication engine 210 may crop or segment the government-issued identifier image to improve the accuracy of subsequent name correspondence score determination operations. For example, authentication engine 210 may retrieve a government-issued identifier template set that may comprise a plurality of templates associated with common government-issued identifiers, such as a passport, driver's license, ID cards, or the like, that identify the location of the name on a particular government-issued identifier. To this end, authentication engine 210 may retrieve the government-issued identifier template set from a local storage device (e.g., memory 204) and utilize the government-issued identifier template set to crop and/or segment the government-issued identifier image. In some embodiments, the preprocessed government-issued identifier image may be stored in a user profile to which the government-issued identifier image corresponds.

Authentication engine 210 may then utilize any suitable method to extract the name that is depicted in the government-issued identifier image. For example, authentication engine 210 may leverage an optical character recognition (OCR) model to extract the name in the government-issued identifier image. In this regard, authentication engine 210 may provide the government-issued identifier image to the OCR model. The OCR model may then identify text regions likely associated with a name, such as a name field, given name filed, surname field, or the like. Moreover, the OCR model may analyze any regions of the government-issued identifier image likely associated with a name by identifying the horizontal lines of text in a region, segmenting the line into individual words, and segmenting each word into its constituent characters.

In some embodiments, the OCR model may then use machine learning to recognize each individual character. For example, the OCR model may extract particular features (e.g., edges, curves, corners, or the like) associated with the name included in the government-issued identifier image. In some embodiments, the OCR model may match the detected characters to predefined character templates (e.g., stored in a local storage device, such as memory 204) to determine the particular characters included in a name in the government-issued identifier image. Additionally or alternatively, the OCR model may determine the particular character associated with a detected character in a government-issued identifier image via machine learning. For example, in an instance in which the OCR model is a machine learning model, the OCR model may determine a particular character associated with each a detected character in the government-issued identifier image based on the one or more features that are extracted about the detected character. In some embodiments, upon determining the individual characters in a particular region of the government-issued identifier image, the OCR model may generate a word based on the position and/or spacing of each determined character and corresponding whitespace. For example, if the OCR model recognized the characters “J”, “u”, “l”, “i”, “a”, the OCR model may combine the characters to form the word “Julia.”

In some embodiments, upon the generation of the words included in the regions of the government-issued identifier image that most-likely correspond to a name, the OCR model may utilize named entity recognition (NER) to identify proper nouns (e.g., names) in the above-described generated (e.g., by the OCR model) words. Moreover, the OCR model may include post-processing techniques to refine its output (e.g., generated words). For example, the OCR model may leverage an OCR correcting algorithm to correct common mistakes in the OCR model, such as misreading the letter ‘o’ as the number ‘0’.

In some embodiments, authentication engine 210 may receive an output from the OCR model that corresponds to a name included in the government-issued identifier image. Subsequently or in parallel to the operations performed by the OCR model, authentication engine 210 may retrieve a name included in a corresponding user profile (e.g., a user profile associated with the user that transmitted the enhanced authentication request). In some embodiments, authentication engine 210 may use any suitable method for generating a name correspondence score by using one or more features associated with the similarity between the name included in the government-issued identifier image to the name included in the corresponding user account or user profile. For example, authentication engine 210 may generate one or more features (e.g., an exact match result) based on whether the name included in the government-issued identifier image and the name retrieved from the user profile are an exact match. In another example, authentication engine 210 may generate one or more features based on applying a fuzzy string matching technique to the name included in the government-issued identifier image and the name retrieved from the user profile. In this regard, authentication engine 210 may calculate a Levenshtein distance value that outputs a value that indicates the minimum number of singular character edits (e.g., insertions, deletions, substitutions, or the like) that are required to transform one input name into the other input name. Moreover, authentication engine 210 may determine an exact match result for the prefixes and/or suffixes of the received names.

Upon determining one or more features for two input names (e.g., a name included in a government-issued identifier image and a name retrieved from a corresponding user profile), authentication engine 210 may utilize a name correspondence scoring model to generate the name correspondence score. The name correspondence scoring model may be input one or more features associated with the similarity between the name included in the government-issued identifier image and the name retrieved from a corresponding user profile. For example, authentication engine 210 may provide the name correspondence scoring model a Levenshtein distance measure, and exact match result, a suffix exact match result, a prefix exact match result, or the like. As a result, the name correspondence scoring model may output name correspondence score based on the input one or more features.

As shown by operation 704, the apparatus 200 includes means, such as memory 204, authentication engine 210, or the like, for determining a name verification result. The name verification result may indicate whether the name correspondence score satisfies a name correspondence threshold. The name correspondence threshold may be a predefined threshold. For example, the entity that is providing the secure device-bound passkey enrollment service offered by the passkey enrollment system 102 may store a predetermined name correspondence score threshold in a local storage device (e.g., memory 204, or the like). The predetermined name correspondence score threshold may describe a value or category that a name correspondence score must satisfy in order to produce a particular name verification result (e.g., a successful name correspondence verification result, an unsuccessful name correspondence verification result, or the like). In this regard, authentication engine 210 may retrieve the name correspondence score from a corresponding user profile that is stored in a local storage device and subsequently compare the name correspondence score to a name correspondence threshold to determine a name correspondence result. Authentication engine 210 may then store the name correspondence result in the user profile to which the name correspondence result corresponds.

As shown by operation 706, the apparatus 200 includes means, such as memory 204, authentication engine 210, or the like, for determining the enhanced authentication result based on the name verification result. As discussed above in relation to operation 312, the enhanced authentication result may indicate whether the user that transmitted the enhanced authentication response is successfully or unsuccessfully authentication and may be based on a variety of different data elements included or derived from the enhanced authentication response. In some embodiments, the name verification result may be provided to a machine learning model (e.g., the enhanced authentication model) that may be trained to combine a variety of different input features (e.g., a security result, a government-issued identifier verification result, an image verification result, and/or the like) to ultimately determine an enhanced authentication result. In this regard, authentication engine 210 may retrieve the name verification result from a local storage device (e.g., memory 204, or the like) and subsequently may provide the name verification result to the enhanced authentication model to allow the enhanced authentication model to produce the enhanced authentication result based on the name verification result.

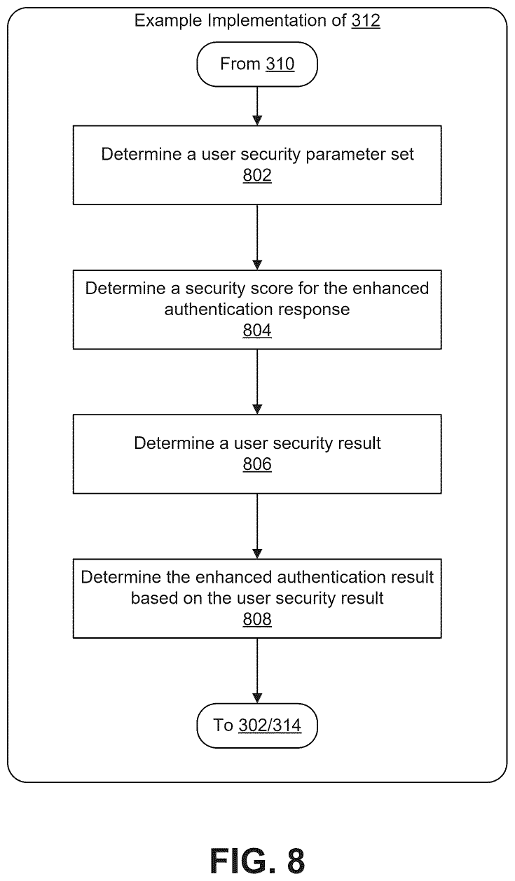

Turning now to FIG. 8, example operations are shown for determining a user security result.

As shown by operation 802, the apparatus 200 includes means, such as=memory 204, authentication engine 210, or the like, for determining a user security parameter set. The user security parameter set may include one or more parameters that are based on enhanced authentication response metadata that may ultimately by used (described below in relation to operation 314) to determine an enhanced authentication result. For example, the enhanced authentication response may include metadata indicative of a location of the user device that transmitted the enhanced authentication request, a date/time that the enhanced authentication response was transmitted to the apparatus 200, or the like. As a result, authentication engine 210 may utilize a secure parameter generation set, which may outline particular rules that may be used to evaluate the metadata associated with the enhanced authentication response. For example, the security parameter generation set may describe that a particular score to assign a particular parameter based on whether the location of the user device that transmitted the enhanced authentication response is within a predefined radius of a known location (e.g., a brick and mortar location associated with the entity providing the secure device passkey enrollment provided by the passkey enrollment system 102, the user's home location, or the like). In another example, the security parameter generation set may describe a particular score to assign a particular parameter based on the time of day that the response was received.

To this end, authentication engine 210 may retrieve the enhanced authentication response from a corresponding user profile that is stored in a local storage device (e.g., memory 204 and may retrieve a security parameter generation set from a local storage device. Subsequently, authentication engine 210 may utilize the retrieved enhanced authentication response and security parameter generation set to determine a user security parameter set. Upon generation of the user security parameter set, authentication engine 210 may store the user security parameter set in a corresponding user profile associated with the user.

As shown by operation 804, the apparatus 200 includes means, such as memory 204, authentication engine 210, or the like, for determining a security score the enhanced authentication response. The security score may be a numerical score (e.g., a value between 0 and 1) that may be used to determine a level of security associated with the metadata associated with the enhanced authentication request. In some embodiments, authentication engine 210 may leverage a security scoring model to determine a security score for the enhanced authentication request. The security scoring model may be a machine learning model that was trained using a corpus of labeled enhanced authentication responses (e.g., with labeled metadata and corresponding ground truth outcome, such as an authentic enhanced authentication response or nonauthentic authentication response). In this regard, authentication engine 210 may provide the security scoring model the security parameter set to allow the security scoring model to account for each parameter included in the security parameter set while generating the security score. Upon generating the security score, authentication engine 210 may store the generated security score in a user profile associated with the user to which the enhanced authentication response corresponds.

As shown by operation 806, the apparatus 200 includes means, such as memory 204, authentication engine 210, or the like, for determining a user security result. The user security result may indicate whether the metadata associated with the enhanced authentication response corresponds to a metadata that is likely associated with a nonauthentic enhanced authentication response (e.g., a tampered enhanced authentication response, or the like). For example, a user security result may be a categorical value of “secure” or “not secure”, a numerical value of 1 for metadata pertaining to a secure enhanced authentication request or 0 for metadata pertaining to an unsecure enhanced authentication request, a Boolean value of “true” for metadata pertaining to a secure enhanced authentication request or “false” for metadata pertaining to an unsecure authentication request, or the like.

In some embodiments, to determine whether the metadata associated with the enhanced authentication response corresponds to metadata associated with a secure on unsecure enhanced authentication response, authentication engine 210 may compare the generated security score (e.g., the security score generated in operation 804) to a predefined security score threshold. For example, a predefined security score threshold may be determined by an entity that is providing the secure device-bound passkey enrollment service offered by the passkey enrollment system 102. For example, the entity may store a predefined security score threshold in a local storage device (e.g., memory 204, or the like). As a result, authentication engine 210 may retrieve the security score threshold and a corresponding security score (e.g., from a user profile) stored in a local storage device and subsequently compare the security score to the security score threshold to determine a user security result (e.g., a successful user security result, an unsuccessful user security result, or the like). In some embodiments, upon determining a user security result, authentication engine 210 may store the user security result in the user profile to the user in which the enhanced authentication response corresponds.

As shown by operation 808, the apparatus 200 includes means, such as memory 204, authentication engine 210, or the like, for determining an enhanced authentication result based on the user security result. As discussed above in relation to operation 312, the enhanced authentication result may indicate whether the user that transmitted the enhanced authentication response is successfully or unsuccessfully authentication and may be based on a variety of different data elements included or derived from the enhanced authentication response. In some embodiments, the user security result may be provided to a machine learning model (e.g., the enhanced authentication model) that may be trained to combine a variety of different input features (e.g., a security result, a government-issued identifier verification result, an image verification result, and/or the like) to ultimately determine an enhanced authentication result. In this regard, authentication engine 210 may retrieve the user security result from a local storage device (e.g., memory 204, or the like) and subsequently may provide the user security result to the enhanced authentication model to allow the enhanced authentication model to produce the enhanced authentication result based on the user security result.

Returning to FIG. 3, as shown by operation 314, the apparatus 200 includes means, such as communications hardware 206, authentication engine 210, or the like, for transmitting a permissioned passkey generation request to a user device. A permissioned passkey generation request may be an electronic request that instructs a user device (e.g., a user device that transmitted the enhanced authentication request, such as user device 106A) to generate a passkey (e.g., an asymmetric key pair that may be later utilized for passkey authentication challenges where the authenticating entity transmits a challenge to a user device, the user device signs the challenge using a private key, and the signed challenge is verified using the corresponding public key). In some embodiments, the permissioned passkey generation request is transmitted to a corresponding user device (e.g., user device 106A), in response to the determination of a particular enhanced authentication result (e.g., a successful enhanced authentication result). Additionally, the permissioned passkey generation request may comprise instructions that instruct the user device to transmit a corresponding public key (e.g., a public key that was generated via the instructions to generate a passkey) to the apparatus 200 (e.g., communications hardware 206). In some embodiments, authentication engine 210 may leverage communications hardware 206 to transmit the permissioned passkey generation request to the user device to which the enhanced authentication request corresponds (e.g., user device 106A, or the like) via a network (e.g., communications network 104, shown in FIG. 1).

As shown by operation 316, the apparatus 200 includes means, such as memory 204, authentication engine 210, or the like, for receiving a public key from the user device. A public key may refer to a component of asymmetric cryptography (e.g., public-private key cryptography). A public key is one half of an asymmetric key pair and may be used to in the context of a passkey to ultimately decrypted a signed challenge (e.g., a challenge signed by a corresponding private key securely stored on the user device) for user authentication. In some embodiments, upon the transmission of the permissioned passkey generation request that may cause the user device (e.g., user device 106A, or the like) to generate a public-private key pair, the apparatus 200 (e.g., communications hardware 206) may receive the corresponding public key and an indication of the user to which the public key corresponds (e.g., a user ID) via a network (e.g., communications network 104, or the like) from the user device that generated the public-private key pair.

As shown by operation 318, the apparatus 200 includes means, such as memory 204, authentication engine 210, or the like, for storing the public key in a user profile associated with the user. In some embodiments, authentication engine 210 may store the received public key in the user profile to which the public key corresponds. As a result, authentication engine 210, or the like, may retrieve a corresponding public key from the user profile in an instance in which the apparatus 200 is required to decrypt a signed challenge that was signed using the corresponding private key (e.g., for passkey authentication).

FIGS. 3-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved device-bound passkey enrollment. Example embodiments thus provide tools that overcome the problems faced by conventional passkey enrollment systems (e.g., single factor authentication systems). By avoiding the use of conventional passkey enrollment systems, example embodiments thus save time and resources, while also providing a secure enhanced authentication result prior to enabling device-bound passkey enrollment that is based on metadata associated with the request, enhanced authentication information, and/or the like. Moreover, embodiments described herein avoid vulnerabilities associated with merely using a single-factor authentication technique. Finally, by automating functionality that has historically required human analysis, the speed and consistency of the evaluations performed by example embodiments unlocks many potential new functions that have historically not been available, such as the ability to conduct near-real-time dispute resolution.

As these examples all illustrate, example embodiments contemplated herein provide technical solutions that solve real-world problems faced during device-bound passkey enrollment. And while user authentication has been an issue for decades, the recently exploding amount of data made available by recently emerging technology today has made this problem significantly more acute, as the demand for secure authentication methods has grown significantly even while the complexity of bad actor attacks has itself increased. At the same time, the recently arising ubiquity of passkeys has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for device-bound passkey enrollment, the method comprising:
receiving, by communications hardware, a first channel authentication response from a user device associated with a user over a first communication channel;
determining, by an authentication engine and based on the first channel authentication response, a first channel authentication result;
in response to determining a successful first channel authentication result, transmitting, by the communications hardware, an enhanced authentication request to the user device;
receiving, by the communications hardware, an enhanced authentication response from the user device over a second communication channel, wherein the second communication channel is different than the first communication channel;
determining, by the authentication engine and based on the enhanced authentication response, an enhanced authentication result;
in response to the enhanced authentication result corresponding to a successful enhanced authentication result, transmitting, by the communications hardware, a permissioned passkey generation request to the user device;
receiving, by the communications hardware, a public key from the user device; and
storing, by an enrollment engine, the public key in a user profile associated with the user.

2. The method of claim 1, further comprising:
determining, by the authentication engine and based on the first channel authentication response, an authentication factor included in the first channel authentication response, wherein the authentication factor is associated with an authentication factor type;
retrieving, by the authentication engine and based on the authentication factor type, a baseline authentication factor from a user account associated with the user; and
determining, by the authentication engine and based on the authentication factor and the baseline authentication factor, a first channel authentication score for the first channel authentication response, wherein determining the first channel authentication result is based on the first channel authentication score.

3. The method of claim 1, further comprising:
generating, by the authentication engine, an enhanced authentication link, wherein the enhanced authentication link is included in the enhanced authentication request; and
in response to receiving an indication that the user interacted with the enhanced authentication link, establishing, by the authentication engine, an authenticated session with the user device, wherein the enhanced authentication response is received during the authenticated session.

4. The method of claim 3, wherein the enhanced authentication link directs the user device to an endpoint within a mobile application.

5. The method of claim 1, further comprising:
in response to transmitting the enhanced authentication request, receiving, by the communications hardware, an indication of a mobile driver's license (mDL), wherein the indication of the mDL is included in the enhanced authentication response;
transmitting, by the communications hardware, the mDL to an issuing authority system associated with an issuing authority that provisioned the mDL; and
receiving, by the communications hardware and from the issuing authority system, a government-issued identifier validity response, wherein the enhanced authentication result is determined based on the government-issued identifier validity response.

6. The method of claim 1, further comprising:
determining, by the authentication engine and based on the enhanced authentication response, a user security parameter set;
determining, by the authentication engine and based on the user security parameter set, a security score for the enhanced authentication response; and
determining, by the authentication engine and based on the security score, a user security result, wherein the enhanced authentication result is based on the user security result.

7. The method of claim 6, wherein the permissioned passkey generation request to the user device is transmitted in response to determining a successful user security result.

8. The method of claim 1, further comprising:
in response to transmitting the enhanced authentication request, receiving, by the communications hardware, a government-issued identifier image, wherein the government-issued identifier image is included in the enhanced authentication response;
transmitting, by the communications hardware, a dynamic user authentication request to the user device;
receiving, by the communications hardware and based on the dynamic user authentication request, a dynamic user authentication response, wherein the dynamic user authentication response comprises an image of the user;
determining, by the authentication engine, a similarity score indicative of an inferred similarity between the image and the government-issued identifier image; and
determining, by the authentication engine and based on the similarity score, an image verification result, wherein the permissioned passkey generation request is transmitted to the user device in response to determining a successful image verification result.

9. The method of claim 8, wherein the image of the user is captured by the user device during an authenticated session.

10. The method of claim 8, further comprising:
determining, by the authentication engine, a name correspondence score indicative of whether a name depicted in the government-issued identifier image corresponds to a stored name in a user account associated with the user; and
determining, by the authentication engine and based on the name correspondence score, a name verification result, wherein the permissioned passkey generation request is transmitted to the user device in response to determining the successful image verification result and a successful name verification result.

11. An apparatus for device-bound passkey enrollment, the apparatus comprising:
communications hardware configured to receive a first channel authentication response from a user device associated with a user over a first communication channel;
an authentication engine configured to determine, based on the first channel authentication response, a first channel authentication result;
wherein the communications hardware is further configured to:
in response to determining a successful first channel authentication result, transmit an enhanced authentication request to the user device, and
receive an enhanced authentication response from the user device over a second communication channel, wherein the second communication channel is different than the first communication channel;
wherein the authentication engine is further configured to determine, based on the enhanced authentication response, an enhanced authentication result;
wherein the communications hardware is further configured to:
in response to the enhanced authentication result corresponding to a successful enhanced authentication result, transmit a permissioned passkey generation request to the user device, and
receive a public key from the user device; and
an enrollment engine configured to store the public key in a user profile associated with the user.

12. The apparatus of claim 11, wherein the authentication engine is further configured to:
determine, based on the first channel authentication response, an authentication factor included in the first channel authentication response, wherein the authentication factor is associated with an authentication factor type;
retrieve, based on the authentication factor type, a baseline authentication factor from a user account associated with the user; and
determine, based on the authentication factor and the baseline authentication factor, a first channel authentication score for the first channel authentication response, wherein determining the first channel authentication result is based on the first channel authentication score.

13. The apparatus of claim 11, wherein the authentication engine is further configured to:
generate an enhanced authentication link, wherein the enhanced authentication link is included in the enhanced authentication request; and
in response to receiving an indication that the user interacted with the enhanced authentication link, establish an authenticated session with the user device, wherein the enhanced authentication response is received during the authenticated session.

14. The apparatus of claim 11, wherein the communications hardware is further configured to:
in response to transmitting the enhanced authentication request, receive an indication of a mobile driver's license (mDL), wherein the indication of the mDL is included in the enhanced authentication response;
transmit the mDL to an issuing authority system associated with an issuing authority that provisioned the mDL; and
receive, from the issuing authority system, a government-issued identifier validity response, wherein the enhanced authentication result is determined based on the government-issued identifier validity response.

15. The apparatus of claim 11, wherein the authentication engine is further configured to:
determine, based on the enhanced authentication response, a user security parameter set;
determine, based on the user security parameter set, a security score for the enhanced authentication response; and
determine, based on the security score, a user security result, wherein the enhanced authentication result is based on the user security result.

16. The apparatus of claim 11, wherein the authentication engine is further configured to:
in response to transmitting the enhanced authentication request, receive a government-issued identifier image, wherein the government-issued identifier image is included in the enhanced authentication response;
transmit a dynamic user authentication request to the user device;
receive, based on the dynamic user authentication request, a dynamic user authentication response, wherein the dynamic user authentication response comprises an image of the user;
determine a similarity score indicative of an inferred similarity between the image and the government-issued identifier image; and
determine, based on the similarity score, an image verification result, wherein the permissioned passkey generation request is transmitted to the user device in response to determining a successful image verification result.

17. The apparatus of claim 16, wherein the authentication engine is further configured to:
determine a name correspondence score indicative of whether a name depicted in the government-issued identifier image corresponds to a stored name in a user account associated with the user; and
determine, based on the name correspondence score, a name verification result, wherein the permissioned passkey generation request is transmitted to the user device in response to determining the successful image verification result and a successful name verification result.

18. A computer program product for device-bound passkey enrollment, the computer program product comprising a non-transitory computer-readable storage medium storing instructions that, when executed by an apparatus, cause the apparatus to:
receive a first channel authentication response from a user device associated with a user over a first communication channel;
determine, based on the first channel authentication response, a first channel authentication result;
in response to determining a successful first channel authentication result, transmit an enhanced authentication request to the user device;
receive an enhanced authentication response from the user device over a second communication channel, wherein the second communication channel is different than the first communication channel;
determine, based on the enhanced authentication response, an enhanced authentication result;
in response to the enhanced authentication result corresponding to a successful enhanced authentication result, transmit a permissioned passkey generation request to the user device;
receive a public key from the user device; and
store the public key in a user profile associated with the user.

19. The computer program product of claim 18, wherein the instructions, when executed by the apparatus, further cause the apparatus to:
determine, based on the first channel authentication response, an authentication factor included in the first channel authentication response, wherein the authentication factor is associated with an authentication factor type;
retrieve, based on the authentication factor type, a baseline authentication factor from a user account associated with the user; and
determine, based on the authentication factor and the baseline authentication factor, a first channel authentication score for the first channel authentication response, wherein determining the first channel authentication result is based on the first channel authentication score.

20. The computer program product of claim 18, wherein the instructions, when executed by the apparatus, further cause the apparatus to:
generate an enhanced authentication link, wherein the enhanced authentication link is included in the enhanced authentication request; and
in response to receiving an indication that the user interacted with the enhanced authentication link, establish an authenticated session with the user device, wherein the enhanced authentication response is received during the authenticated session.
